(19) United States
(12) Patent Application Publication
(10) Pub. No.: US 2006/0236576 A1
(43) Pub. Date: Oct. 26, 2006

(54) Clasp for hanging material

(76) Inventor: Stuart C. W. Wear, St. Louis Park, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/103,243

(22) Filed: Apr. 11, 2005

(51) Int. Cl. G09F 15/00

(52) U.S. Cl. 40/607.14

(57) ABSTRACT

A poster clasp, includes a substantially T-shaped frame having a cross bar defining a suspension assembly and a depending backplate, an overcenter clasp assembly being disposed on a first side of the backplate and a strengthening arch being oppositely disposed on a second side of the backplate.

### RELATED PATENT

The present application is related to U.S. Pat. No. 6,637.716, owned by the same entity.

### TECHNICAL FIELD

Present invention relates to clasps. More particularly, the present invention relates to clasps for grasping and suspending material such as posters, signage and the like.

### BACKGROUND OF THE INVENTION

There is a need for devices that grip posters and signage for suspension of the posters and signage from the devices. Such devices may be suspended by means of cords from a ceiling of a room or may be affixed to a wall of a room as by pins and the like. The clips should be designed to readily receive and engage the posters such that the posters may be frequently changed as desired. The clips should have sufficient friction and/or compressive force to bear the weight of the poster in suspension.

There are a number of clips in use for the aforementioned purposes. One of such clips is as described in U.S. Pat. No. 4,899,974 issued Feb. 13, 1990 and assigned to the assignee of the present application.

Certain prior art clips have failed to meet certain needs of the industry. The first such need is to provide sufficient clamping engagement to support the weight of a suspended poster. In the past, certain designs of the prior art have not evidenced sufficient friction or compressive forces and posters had been known to pull free of the clip. Accordingly, there is a need in the industry to increase the friction and/or compression forces exerted by the clip on the poster.

A second need of the industry is to provide for ready insertion of the poster stock into the opening defined in the clip. Certain prior art clips required prying the clip away from a back plate to define an opening. Certain other prior art devices had a hinged clip but the hinge did not have a very extensive range of angular motion and accordingly the opening that was able to be defined was not very great. In both cases, inserting the poster into the clip was something akin to threading the eye of a needle.

A third need is to be able to engage the clip with the poster stock without crumpling the inserted portion of the poster stock in the receiving space defined within the clip. There are a number of different kinds of poster stock that are typically used. Some of such stock is made of relatively slippery-coated material, typically having an aqueous coating or being laminated. A further stock is uncoated paper. A final stock is formed of a much softer material that has a much higher coefficient friction. Such stock might be formed of PVC material. In the past, especially with a hinged clip, the engaging portion of the clip would early engage the soft stock. Due to the increased coefficient of a friction, continued rotation of the clip into the engaging position acted to carry the greater portion of the soft stock into the receiving space defined within the clip. The effect is then that the clip crumples the portion of the soft stock that is carried into the receiving space defined within the clip.

A fourth need is for the clamp to have the strength to support very long posters, on the order of ten feet in length. Further, the clamp should additionally be formable in a rectangular shape to provide a frame for a poster.

### SUMMARY OF THE INVENTION

The present invention substantially meets the aforementioned needs of the industry. The retention of the poster within the clamp is enhanced in at least three ways. First, the clip is hinged and has a cammed portion that engages the poster compressively. Further, the point of engagement of the hinged clip bears on a ramped non-skid (high friction) portion. The ramp (cam point) provides for the camming of the hinged portion, while the non-skid material increases the friction existing between the surface of the poster stock and the back plate of the clamp.

Secondly, as indicated above, the engaging portion of the clamp is hinged. The actual hinge is preferably formed of a material that provides for a substantially increased range of rotational motion of the hinged portion. In such manner, a relatively large opening is defined to facilitate insertion of the poster stock into the receiving space defined within the clamp. Additionally, the hinged portion of the clamp includes a C-shaped (or backwards J-shaped) engaging member. The C-shaped engaging member generally defines a funnel when the hinged portion is in the open position. The funnel assists in guiding the poster stock into the receiving space defined within the clamp.

Thirdly, the design of the hinged portion of the clamp is such that the peak pressure exerted on the poster stock is delayed until the latter portion of the rotation of the hinged portion into the closed (engaged) disposition. The delay of the peak pressure exerted on the poster stock facilitates minimizing the crumpling of the portion of the poster stock that is caught up by the hinged portion of the clamp and carried into the receiving space defined within the clamp. Delaying the peak compressive force until the latter portions of rotation of the hinged portion is a method of minimizing the crumpling of poster stock, especially the relatively soft, high frictional poster stock.

Fourthly, the clamp of an embodiment of the present invention includes a strengthening arch opposite the hinged portion of the clamp, which provides sufficient strength for providing adequate support for very long posters. Additionally the clamp includes interlocking corner pieces for forming four sections of the clamp into a rectangular poster frame

The present invention is a poster clasp including a substantially T-shaped frame having a cross bar defining a suspension assembly and a depending backplate, an overcenter clasp assembly being disposed on a first side of the backplate and a strengthening arch being oppositely disposed on a second side of the backplate.

### BRIEF DESCRIPTION OF THE DRAWINGS

FIG. 1 is a perspective view of an embodiment of the poster clasp of the present invention;

FIG. 1 a is an end elevational view of the poster clasp of claim 1;

FIG. 2 is a perspective view of another embodiment of the poster clasp of the present invention;

FIG. 2a is an end elevational view of the poster clasp of claim 2;

FIG. 3 is a perspective view of another embodiment of the poster clasp of the present invention;

FIG. 3a is an end elevational view of the poster clasp of claim 3;

FIG. 4 is a perspective view of a further embodiment of the poster clasp of the present invention;

FIG. 5 is a perspective view of a further embodiment of the poster clasp of the present invention;

FIG. 6 is a perspective view of an embodiment of the poster clasp of the present invention supporting a poster, with a second poster clasp to weigh the poster down;

FIG. 7 is a perspective view of a further preferred embodiment of the poster clasp of the present invention in the closed disposition;

FIG. 8 is a perspective view of the embodiment of the poster clasp of the present invention of FIG. 7 in the open disposition;

FIG. 9 is a perspective view of a strengthened embodiment of the present invention;

FIG. 10 is an end cap for the embodiment of FIG. 9;

FIG. 11 is a corner attachment for the embodiment of FIG. 9; and

FIG. 12 is an elevational view of a rectangular poster frame formed of the corner attachment and the embodiment of FIG. 9.

### DETAILED DESCRIPTION OF THE DRAWINGS

The poster clasp of the present invention is shown generally at 10 in the figures. Poster clasp 10 has two major components that include suspension assembly 12 and clasp assembly 14.

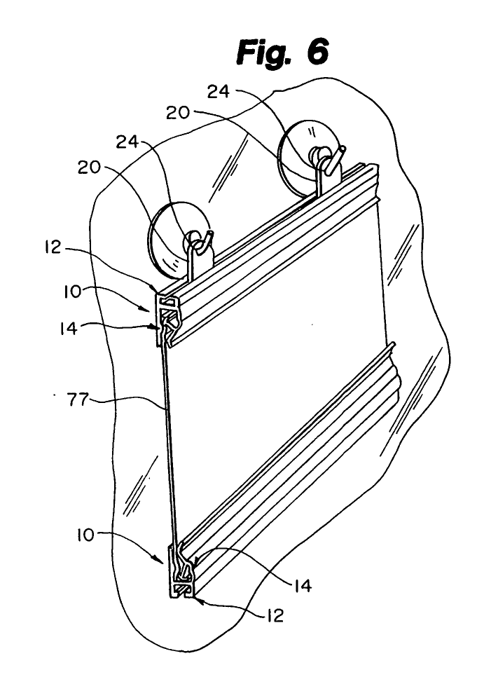

The suspension assembly 12 includes a clip 20 and a clip receiver 22. The clip 20 has a clip aperture 24 defined therein. The clip aperture 24 is useful for passing a cord there through to suspend the poster clasp 10 from a room ceiling or other structure. Additionally, a fastener such as a screw or hook (see FIG. 6) may be passed through the clip aperture 24 and engaged with a room wall to support the poster clasp 10 in fixed engagement with the room wall.

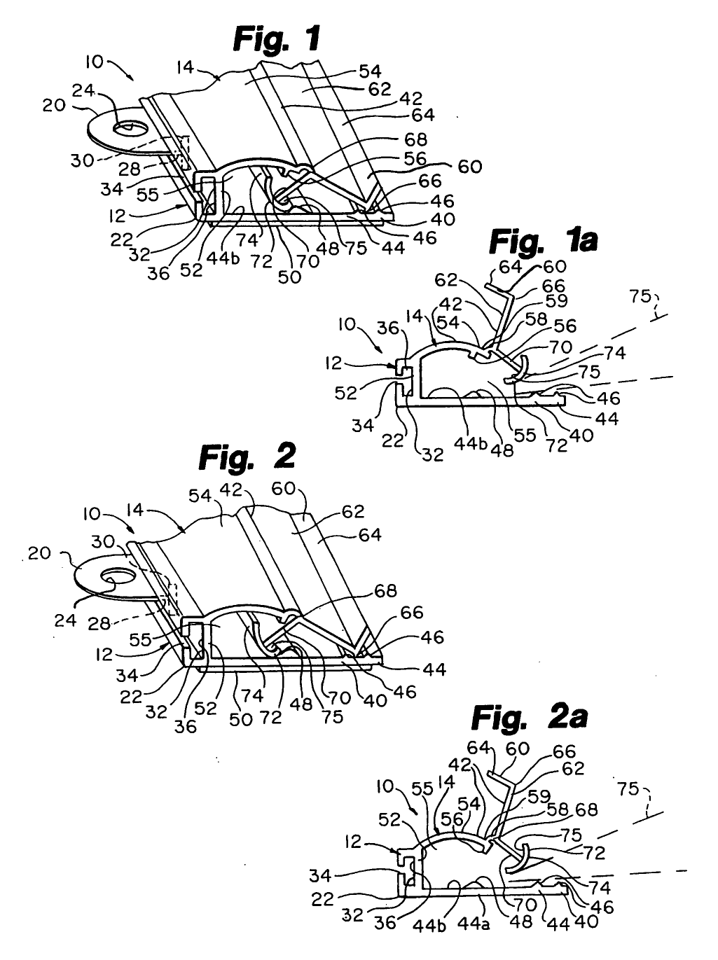

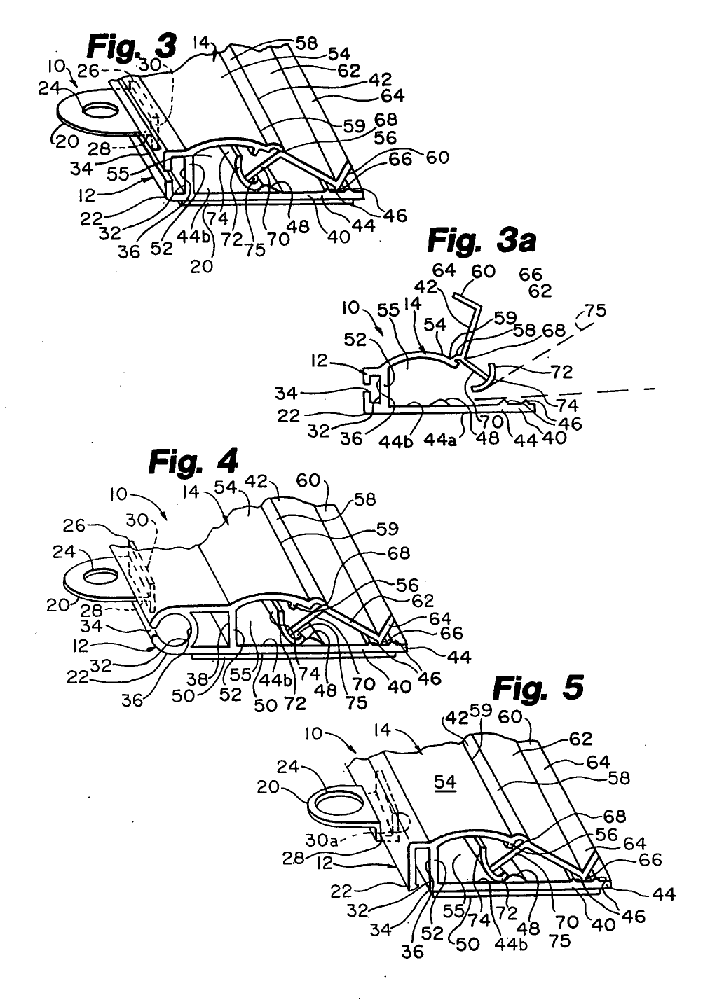

The clip 20 includes a slidable retainer 26. The slidable retainer 26 may be generally defined by an inverted T shape (see FIGS. 1-4) having a shank 28 and a crossbar 30 coupled to the shank 28.

The clip receiver 22 has a receiver groove or rail 32 defined therein. The rail 22 extends preferably the full width of the poster clasp 10. In a preferred embodiment, a slot 34 extends through the suspension assembly and intersects the rail 32. The rail 32 preferably has an open end 36 at least on a first end of the suspension assembly 12.

In operation, the clip 20 of FIGS. 1-4 is inserted into the rail 32 via the open end 36. The slidable retainer 26 is captured within the rail-32 and the shank 28 of the clip 20 projects through the slot 34 to extend upward therefrom when the poster clasp 10 is in a suspended disposition. A plurality of clips 20 may be disposed within the rail 32 as desired and due to the slidable relationship of the clip 20 to the clip receiver 22, the clip 20 may be positioned as desired within receiver rail 32.

Referring to FIGS. 4 and 5, alternative embodiments of a suspension assembly 12 may be used with the clasp assembly 14. In the depiction of FIG. 4, the suspension assembly 12 has a receiver rail 32 that is generally circular in cross section. A clip 20 that is similar to the previously described clip 20 may be inserted within the circular receiver rail 32. An enclosed connector rail 38 resides beneath the circular receiver rail 32. The connector rail 38 is preferably open on both ends. In operation, an elongate connector bar (not shown) can be slid partially into the connector rail 38 of a first poster clasp 10 and partially into the connector rail 38 of a second poster clasp 10 in order to connect two adjacent poster clasps 10 together to support a poster that is longer than a standard length poster clasp 10.

Referring to FIG. 5, the suspension assembly 12 again includes both a clip 20 and a clip receiver 22. The clip 20 has a depending shank 28. The shank 28 forms a generally L shape with the crossbar 30A. The receiver rail 32 has a side opening slot 34 for receiving the cross bar 30A therein.

The poster clasp 10 is a unitary, integral design preferably formed in a single extruding step with the suspension assembly 12 and the clasp assembly 14 both being formed during that step. As indicated above, the clasp assembly 14 may be used with a number of different suspension assemblies 12.

Turning now to the description of the clasp assembly 14 of the poster clasp 10, the clasp assembly 14 has two subcomponents; support member 40 and hinged gripping member 42. The support member 40 of the clasp assembly 14 includes a back plate 44. The back plate 44 has an outer margin 44A and an opposed inner margin 44B. The outer and inner margins 44A, 44B are generally planar and extend the full width of the poster clasp 10. In a preferred embodiment, a pair of gripping ridges 46 are formed on the inner margin 44B. The gripping ridges 46 are spaced slightly apart and preferably extend the full width of the poster clasp 10.

A raised ramp or cam point 48 is also formed on the inner margin 44B. The cam point 48 preferably extends the full width of the poster clasp 10 and may be both lower and wider than as depicted. The cam point 48 is co-extruded with the extrusion that forms the poster clasp 10. The material forming the cam point 48 is generally softer than the material forming the rest of the poster clasp 10 and accordingly has a lower durometer number than the rest of the poster clasp 10, durometer being a measurement used to denote the hardness of a material (usually of thermosetting and thermoplastic materials). Notwithstanding the fact that the material forming the remainder of the poster clasp 10 and forming the cam point 48 are different, they are capable of being co extruded. The fact that the durometer number of the cam point 48 is reduced contributes to the fact that the friction existing between the cam point 48 and poster stock to be suspended from the poster clasp 10 is greater than would exist between the poster stock and a material of higher durometer number. This effectively increases the retaining potential of the poster clasp 10 exerted on poster stock inserted therein.

A tape strip 50 (see FIGS. 1-5) may be applied to the outer margin 44A of the back plate 44. The tape strip 50 typically has adhesive on both sides that is preferably covered by a release liner (not shown). A first release liner is removed from the tape strip 50 exposing the adhesive on a first side of the tape strip 50. That side may be then adhered to the outer margin 44A. The release liner of the opposing side of the tape strip 50 is kept in place until immediately prior to adhering the poster clasp 10 to a room wall surface or the like.

A cross member 52 is formed generally transverse to the back plate 44 and extends from the upper margin of the back plate 44. A hinge support 54 depends from the cross member 52 and is spaced apart from the back plate 44. A receiving aperture 55 is defined generally by the inner margin 44A of the back plate 44, the inner margin of the cross member 52, and the inner margin of the hinge support 54.

Preferably, the hinge support 54 has a generally arcuate shape and extends the full width of the poster clasp 10. A strengthening rib 56 that also extends the full width of the poster clasp 10 may be formed on the inner margin of the hinge support 54. One or more of such strengthening ribs 56 may be utilized in this manner as needed. The strengthening rib may be placed closed to the distal end margin of the hinge support (see FIGS. 2, 2a and 5) or may be spaced apart from the distal end margin of the hinge support (see FIGS. 1, 1a, and 4).

A preferably arched hinge 58 is integrally formed between the support member 40 and the hinged gripping member 42. The hinge 58 is preferably formed at a lower margin 59 of the hinge support 54. The material forming the hinge 58 is preferably the same material as forms the cam point 48 and is therefore generally softer than the material forming the rest of the poster clasp 10 and accordingly has a lower durometer number than the rest of the poster clasp 10. Notwithstanding the fact that the material forming the remainder of the poster clasp 10 and forming the arched hinge 58 are different, they are capable of being co extruded. The fact that the durometer number of the arched hinge 58 is reduced contributes to the fact that the arched hinge 58 has a relatively great range of rotational motion between an open disposition and a closed disposition, which, as will be seen contributes to forming a wide opening for the insertion of poster stock into the poster clasp 10.

The hinged gripping member 42 includes a gripping leg 60. The gripping leg 60 generally has the features of a human leg and will be so described. Accordingly, the gripping leg 60 has a lower leg portion 62 that is connected to a foot 64 at an intersection comprising a heel 66. Preferably, the foot 64 is disposed at an angle relative to the lower leg portion 62 of between 45 and 135 degrees. In the depiction of FIG. 1, a preferred included angle defined between the foot 64 and the lower leg portion 62 is about 100 degrees.

An upper leg portion 70 is joined to the lower leg portion 62 at a knee 68. It should be noted that the hinge 58 is fixedly joined to the gripping leg 60 proximate the knee 68. The upper leg portion 70 has an arcuate or C-shaped lobe 72 disposed at the distal end of the upper leg portion 70. The distal end of the upper leg portion 70 is joined to the lobe 72 approximately midway through the arc defined by the lobe 72. The outer margin 74 of the lobe 72 is preferably convex while the inner margin 75 of the lobe 72 is preferably concave. It is the outer margin 74 of the lobe 72 that compressively, frictionally engages the poster stock that is suspended from the poster clasp 10.

Rotation of the gripping leg 60 relative to the hinge support 54 is preferably through an arc that commences at the open disposition, as depicted in FIG. 1A, 2A, 3A, and terminates at the closed disposition, as depicted in FIG. 1, 2, 3. The rotation is through an arc between about 45 degrees and 135 degrees, and is most preferably between about 80 and 110 degrees. Engagement with the poster stock that is inserted into the receiving aperture 55 is dependent to a certain degree on the thickness of the poster stock, but generally first occurs on outer margin 74 somewhat prior to the point of intersection of the upper leg portion 70 with the lobe 72. As rotation of the gripping leg 60 is continued, compression of the poster stock increases to a peak pressure that occurs somewhat slightly after the point of intersection of the upper leg portion 70 with the lobe 72. As the lobe 72 passes beyond the cam point 48, pressure on the poster stock decreases somewhat.

At the same time, the heel 66 comes into engagement with the poster stock adjacent the inner margin 44B of the back plate 44 and compresses a portion of the poster stock between the two gripping ridges 46. This forces the ridges 46 to bite into the poster stock. Accordingly, it is the pressure exerted by the trailing portion of the lobe 72 acting on the poster stock captured between the trailing portion of the lobe 72 and the cam point 48 in cooperation with the pressure exerted by the heel 66 on the poster stock, forcing the poster stock into the gripping ridges 46 that acts to retain the poster stock within the poster clasp 10. By delaying the point of maximum compression between the lobe 72 and the cam point 48 until late in the rotation of the lobe 72 between the open disposition of FIGS. 1A, 2A, 3A and the closed disposition of FIG. 1, 2, 3, the tendency to jam a greater portion of the poster stock into the receiving aperture 55 and to crumple such portion is greatly reduced.

Referring to FIGS. 1A, 2A, 3A, where the gripping leg 60 is depicted in the fully open disposition, it is apparent that the lobe 72 creates a funnel 75 that decreases in width dimension as the poster stock is inserted into the receiving aperture 55. The effect of the funnel 75 so defined is to better facilitate inserting the poster stock into the receiving aperture 55. The funnel effect is created by including in the design the arcuate, C-shaped lobe 72 in conjunction with the hinge 58. The hinge 58 permits a relatively large range of motion with the gripping leg 60 which acts to define a relatively large opening, as depicted in FIGS. 1A, 2A, 3A for the insertion of the poster stock into the receiving aperture 55. The curvature of the lobe 72 acts to create the funnel effect into the opening defined between the lobe 72 and the inner margin 45B of the back plate 44.

As depicted in FIG. 6 a first poster clasp 10 can be used to suspend a poster 77 therefrom while a second poster clasp 10 can be disposed on the bottom margin of the poster to generate a certain mass and stiffness at the lower margin of the poster 77 that aids in displaying the poster 77 in a planar manner. No clips 20 are usually utilized with the lower poster clasp 10.

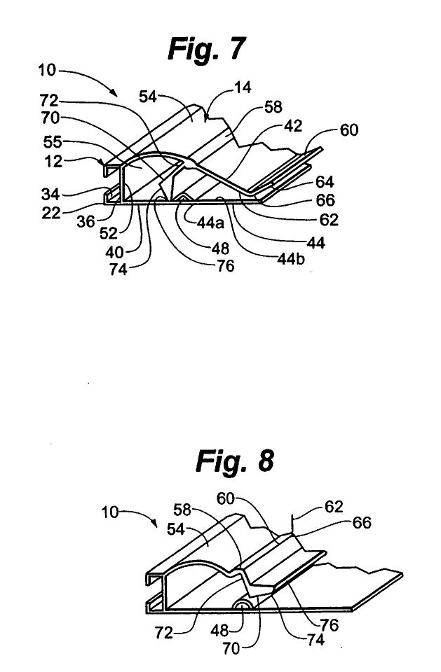

As depicted in FIGS. 7 and 8, the clasp assembly 14 of the poster clasp 10, the clasp assembly 14 has two subcomponents; support member 40 and hinged gripping member 42. The support member 40 of the clasp assembly 14 includes a back plate 44. The back plate 44 has an outer margin 44a and an opposed inner margin 44b. The outer and inner margins 44a, 44b are generally planar and extend the full width of the poster clasp 10.

A raised ramp or cam point 48 is also formed on the inner margin 44a. The cam point 48 preferably extends the full width of the poster clasp 10 and may be both lower and wider than as depicted. The cam point 48 is co-extruded with the extrusion that forms the poster clasp 10. The material forming the cam point 48 is generally softer than the material forming the rest of the poster clasp 10 and accordingly has a lower durometer number than the rest of the poster clasp 10, durometer being a measurement used to denote the hardness of a material (usually of thermosetting and thermoplastic materials). Notwithstanding the fact that the material forming the remainder of the poster clasp 10 and forming the cam point 48 are different, they are capable of being co extruded. In this case, the cam point is preferably formed of a relatively soft material as compared to the material of the back plate 44, and is preferably PVC material. Alternatively, the cam point 48 is formed of the same material of the back plate 44 and is preferably a substantially rigid PVC material.

A tape strip 50 (see FIGS. 1-5) may be applied to the outer margin 44A of the back plate 44. The tape strip 50 typically has adhesive on both sides that is preferably covered by a release liner (not shown). A first release liner is removed from the tape strip 50 exposing the adhesive on a first side of the tape strip 50. That side may be then adhered to the outer margin 44A. The release liner of the opposing side of the tape strip 50 is kept in place until immediately prior to adhering the poster clasp 10 to a room wall surface or the like.

A cross member 52 is formed generally transverse to the back plate 44 and extends from the upper margin of the back plate 44. A hinge support 54 depends from the cross member 52 and is spaced apart from the back plate 44. A receiving aperture 55 is defined generally by the inner margin 44a of the back plate 44, the inner margin of the cross member 52, and the inner margin of the hinge support 54.

Preferably, the hinge support 54 has a generally arcuate shape and extends the full width of the poster clasp 10. A preferably arched hinge 58 is integrally formed between the support member 40 and the hinged gripping member 42. The hinge 58 is preferably formed at a lower margin of the hinge support 54. The material forming the hinge 58 is preferably generally softer than the material forming the rest of the poster clasp 10 and accordingly has a lower durometer number than the rest of the poster clasp 10. Notwithstanding the fact that the material forming the remainder of the poster clasp 10 and forming the arched hinge 58 are different, they are capable of being co extruded. The fact that the durometer number of the arched hinge 58 is reduced contributes to the fact that the arched hinge 58 has a relatively great range of rotational motion between an open disposition and a closed disposition, which, as will be seen contributes to forming a wide opening for the insertion of poster stock into the poster clasp 10.

The hinged gripping member 42 includes a gripping leg 60. The gripping leg 60 has a lower leg portion 62 that is connected to a foot 64 at an intersection comprising a heel. A compression fin 70 is joined to the lower leg portion 62. It should be noted that the hinge 58 is also fixedly joined to the gripping leg 60 proximate to point of connection of the compression fin 70. The compression fin 70 has a fin leg 72 that is preferably formed integral with the hinge 58, and accordingly, the compression fin 70 is preferably formed of a relatively soft material, preferably PVC.

The distal end of the fin leg is connected to foot 74. The toe 76 of the foot 74 is designed to compressively, frictionally engage the poster stock that is suspended from the poster clasp 10.

Rotation of the gripping leg 60 relative to the hinge support 54 is preferably through an arc that commences at the open disposition, as depicted in FIG. 8, and terminates at the closed disposition, as depicted in FIG. 7. The rotation is through an arc between about 45 degrees and 135 degrees, and is most preferably between about 80 and 110 degrees. Engagement with the poster stock that is inserted into the receiving aperture 55 is dependent to a certain degree on the thickness of the poster stock, but generally first occurs on the toe 76. As rotation of the gripping leg 60 is continued, compression of the poster stock increases to a peak pressure at appoint that is disposed on a line that is orthogonal with the back plate 44 and intersects the hinge 48. As the foot 74 passes beyond the cam point 48, pressure on the poster stock decreases somewhat.

At the same time, the heel 66 comes into engagement with the poster stock adjacent the inner margin 44b of the back plate 44 and compresses a portion of the poster stock. Accordingly, it is the pressure exerted by the toe 76 acting on the poster stock captured adjacent the cam point 48 in cooperation with the pressure exerted by the heel 66 on the poster stock that acts to retain the poster stock within the poster clasp 10. By delaying the point of maximum compression between the toe 76 and the cam point 48 until late in the rotation of the compression fin 70, there is a reduced tendency for the toe 76 to gather and to jam a greater portion of the poster stock into the receiving aperture 55 and to crumple such portion.

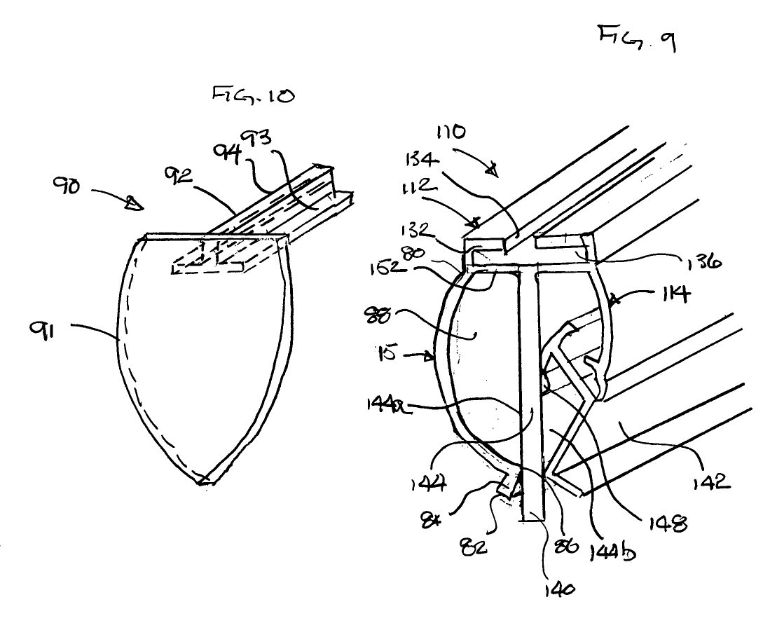

A strengthened embodiment of the poster clasp is depicted in FIG. 9. Similar components of the embodiment of FIG. 9 that are described above in relationship to the embodiments of FIGS. 1-8, are indicated by a numeral that is one hundred numbers greater then the numeral used immediately above for the corresponding component.

The poster clasp 110 is shown generally in FIG. 9. The poster clasp 110 has major subcomponents including suspension assembly 112, clasp assembly 114, and strengthening arch 115. As noted above, there is a need in the industry to support very long posters, extending as much as ten feet. In order to support such posters without bending, the poster clasp 110 must exhibit substantially more longitudinal strength then the embodiments of FIGS. 1-8. In response to this requirement, the generally arcuate arch 15 has been added to the poster clasp 110. The suspension assembly 112 of the poster clasp 110 has been widen, which additionally strengthens the poster clasp 110. The suspension assembly 112 is formed on a cross member 152. The suspension assembly 112 includes a rail 132 spaced apart from the cross member 152. The rail 132 has a centrally disposed slot 134 formed therein. As with the embodiments above, the suspension assembly 112 accommodates a clip 120 which may be slid into the open end 136 of the suspension assembly 112.

It is understood that the exemplary suspension assembly system 112 may be supplanted by either of the alternative suspension assemblies depicted in FIGS. 1-8.

The clasp assembly 114 of the poster clasp 110 includes a support member 140 and a hinged gripping member 142.

The support member 140 includes a depending backplate 144 that depends from the cross member 152. The backplate 144 has an outer margin 144a and an inner margin 144b. A cam point 148 that operates cooperatively with the hinged gripping member 142 is disposed on the inner margin 144b in other respects, the hinged gripping member 142 can be any of the embodiments disclosed in FIGS. 1-8.

The strengthening arch 15 is formed integral to the remainder of the poster clasp 110 and is coupled at a proximal end 80 at an edge margin of the cross member 152. The strengthening arch 15 is generally is arcuate in shape and extends downward alongside the backplate 144 and has generally the same arch shape as the clasp assembly 114. As depicted in FIG. 9, the strengthening arch 15 is oppositely disposed with respect to the clasp assembly 114 and is adjacent to outer margin 144a, whereas the clasp assembly 114 is adjacent to inner margin 144b.

An outward directed foot 84 is formed at the distal end 82 of the strengthening arch 15. A heel 86 of the foot 84 is in compressive engagement with the outer margin 144a of the backplate 144. The foot 84 could be grasped, pulling the distal end 82 away from the backplate 144 and a poster slipped therein and gripped by the strengthening arch 15. Such poster would then reside within the inner channel 88 formed between the strengthening arch 15 and the backplate 144.

FIG. 10 depicts a endplate assembly 90. The endplate assembly 90 has an endplate 91 and a projection 92. The endplate 91 has a generally shield-shape the outer margin of which conforms to the arch shape of both the clasp assembly 114 and the strengthening arch 15, such that when the endplate assembly 90 is coupled to the poster clasp 110 the open end of the poster clasp 110 that is presented in FIG. 9 is substantially covered.

The projection 92 of the endplate assembly 90 is disposed substantially orthogonally with respect to the plane of the endplate 91. The projection 92 is formed generally as an inverted T, having a crossbar 93 and a centrally disposed upright 94. The projection 92 is suitably sized to mate with the suspension assembly 112 of the poster clasp 110.

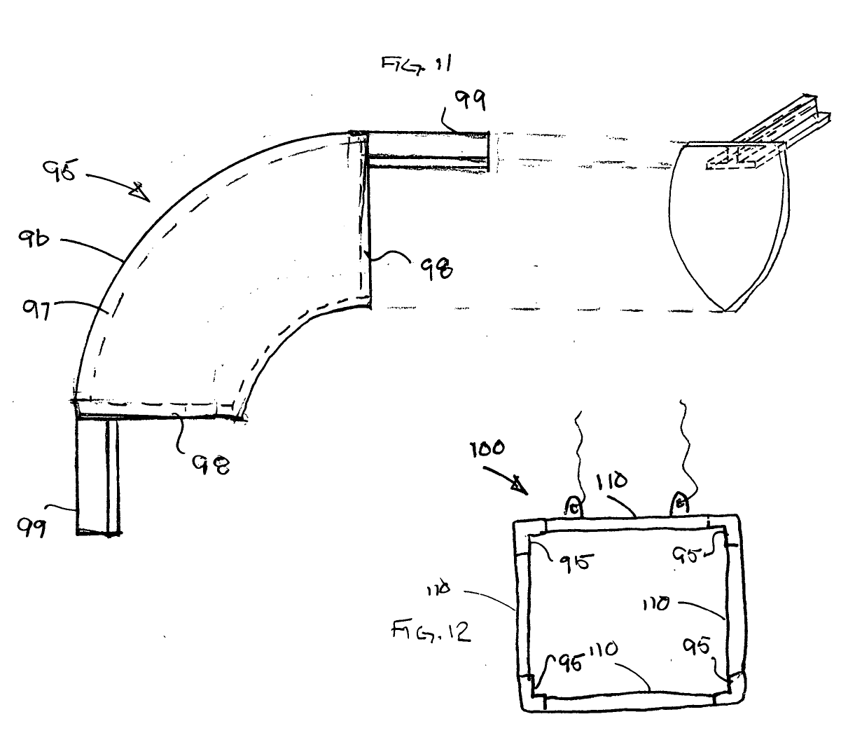

A corner attachment 95 is depicted in FIG. 11. The corner attachment 95 has a generally tubular body 96 having a body wall 97. The shape of the tubular body 96 is preferably that of the endplate assembly 90, I described above. The corner attachment 94 is formed in an arc of substantially 90°.

The corner attachment 95 has two orthogonally disposed ends that are capped by respective endplates 98. Each endplate 98 has an outward directed projection 99 formed substantially in accordance with the endplate assembly 90, described above.

In operation, a first projection 99 is inserted into the suspension assembly 112 of a first poster clasp 110. The second projection 99 is inserted into the suspension assembly 112 of a second poster clasp 110, thereby coupling the two poster clasps 110 in an orthogonal relationship.

By using four poster clasps 110 and four corner attachments 95, as depicted in FIG. 12, a rectangular poster frame 100 maybe formed. In such poster frame 100, adjacent poster clasp 110 coupled in an orthogonal disposition by a corner attachment 95. It should be noted that the corner attachment 95 can be made in a more right angle form as depicted in FIG. 12 as distinct from the curved depiction of FIG. 11.

It will be obvious to those skilled in the art that other embodiments in addition to the ones described herein are indicated to be within the scope and breadth of the present application. Accordingly, the applicant intends to be limited only by the claims appended hereto.

What is claimed is:

1. An improved poster clasp for suspending a poster therefrom, including a suspension assembly having at least one suspension device for operable, suspending cooperation with a surface and a clasp assembly being formed integrally, unitarily with the suspension assembly, the clasp assembly having a support member and a hinged gripping member, the support member having a cam point formed integral with a backplate, and the hinged gripping member having a hingedly rotatable compression fin, the compression fin being rotatable between an open disposition and a closed disposition, the compression fin being formed integral with a hinge and being formed of a relatively soft material, the improvement comprising:
a strengthening arch formed integral with the suspension assembly and being oppositely disposed with respect to the support member and the hinged gripping member.

2. The poster clasp of claim 1 wherein the strengthening arch is coupled at a proximal end to the suspension assembly and bears upon the backplate at a distal end.

3. The poster clasp of claim 2 wherein the strengthening arch defines an interior opening with the backplate.

4. The poster clasp of claim 1, wherein the strengthening arch has an outward directed lip at the distal end thereof.

5. The poster clasp of claim 1 including an end plate having a projection for being operably coupled to the suspension assembly.

6. The poster clasp of claim 5 wherein the end plate projection is T-shaped in cross section.

7. The poster clasp of claim 1 including a right angle connector, the connector having two orthogonally disposed projections, each projection for being operably coupled to the suspension assembly

8. The poster clasp of claim 7 wherein the connector projections are T-shaped in cross section.

9. The poster clasp of claim 1 being formed in a rectangular disposition having four segments, each segment being orthogonally joined to two adjacent segments by a right angle connector.

10. A poster clasp, comprising:
a substantially T-shaped frame having a cross bar defining a suspension assembly and a depending backplate, an overcenter clasp assembly being disposed on a first side of the backplate and a strengthening arch being oppositely disposed on a second side of the backplate.

11. The poster clasp of claim 10 wherein the strengthening arch is coupled at a proximal end to the cross bar and bears upon the backplate at a distal end.

12. The poster clasp of claim 11 wherein the strengthening arch defines an interior opening with the backplate.

13. The poster clasp of claim 10, wherein the strengthening arch has an outward directed lip at the distal end thereof.

14. The poster clasp of claim 10 including an end plate having a projection for being operably coupled to the suspension assembly.

15. The poster clasp of claim 14 wherein the end plate projection is T-shaped in cross section.

16. The poster clasp of claim 10 including a right angle connector, the connector having two orthogonally disposed projections, each projection for being operably coupled to the suspension assembly.

17. The poster clasp of claim 16 wherein the connector projections are T-shaped in cross section.

18. The poster clasp of claim 1 being formed in a rectangular disposition having four segments, each segment being orthogonally joined to two adjacent segments by a right angle connector.
